(19) United States
(12) Patent Application Publication
(10) Pub. No.: US 2014/0339107 A1
(43) Pub. Date: Nov. 20, 2014

(54) RFID PLAQUE BOX

(71) Applicant: Gaming Partners International Corporation, Las Vegas, NV (US)

(72) Inventors: Emmanuel Gelinotte, Savigny Les Beaune (FR); Bernard Molina, Saint-Marcel (FR); Miguel Choi, Taipa (MO); Scott McCarthy, Macau (CN); Benjamin Raz, Taipa (MO); Kirsten Clark, Las Vegas, NV (US); Gregory Scott Gronau, Las Vegas, NV (US); Regis Marcel Roger Vicaire, Marigny Les Reullee (FR)

(73) Assignee: Gaming Partners International Corporation, Las Vegas, NV (US)

(21) Appl. No.: 13/896,605

(22) Filed: May 17, 2013

(51) Int. Cl. G06K 19/077

(52) U.S. Cl. CPC G06K 19/07749
USPC 206/216

(57) ABSTRACT

An RFID plaque box provides secure storage and protection of value tokens (e.g., gaming plaques and jetons) of all sizes and shapes (e.g., rectangular, square, oval or round) and delivers real-time counting and movement details in both high and low frequency RF environments. The RFID plaque box allows plaques or jetons to be accounted for as part of the table's inventory along with the RFID chip tray's inventory (when installed). The RFID plaque box is provided as a fixed storage area that is situated below the plan of the gaming table alongside the RFID chip tray (when provided) with a lid very similar to that of the RFID chip tray or provided in a pop-up mechanism whereby the RFID plaque box is integrated into a gaming table such that when the top surface of the RFID plaque box is pushed, the RFID plaque box will pop-up to lift the stacks of plaques or jetons for access.

### TECHNICAL FIELD

The invention is directed to trays for storing gaming currency such as value tokens. Value tokens are physical objects that represent cash or other value and are acceptable, at least in certain circumstances, as having a represented cash equivalent or other value. Exemplary among the uses of value tokens are their use in casino gaming where, as chips, plaques or jetons, they form a basis for placing, tracking and honoring wagers. Value tokens also take the form of traditional coinage or currency in common use worldwide. Further, value tokens may be used, e.g. commercially, to represent value in the context of rewards, opportunities, premiums, and the like. In this context, value tokens may be redeemed for other things of value or opportunities having value. The present invention may find utility in any or all of these applications, and, indeed, in all applications where a physical object stands for or represents something of value. More specifically, the invention is directed to a low or high frequency RFID enabled box adapted to store RFID-enabled plaques, jetons, and other value tokens and to communicate with the RFID-enabled plaques, jetons, and other value tokens to provide real-time accounting for the plaques, jetons, and other value tokens and their movements.

### BACKGROUND

Value tokens, such as casino gaming chips, have the attributes of currency and, accordingly, significant steps are taken to track the location and value of such value tokens as well as to prevent their counterfeiting and theft. For example, gaming chips with transponders formed therein are described in U.S. Pat. Nos. 5,166,502; 5,895,321; 6,264,109; 6,296,190; 6,581,747; 7,866,563; 7,918,455; 7,926,725; 7,931,204; and 7,942,334. As described in these applications, the transponders may be molded within plastic injection molded gaming chips and detected using conventional RFID detectors or other readers. The transponders typically transmit unique identification information and value information to such readers for detection and verification.

RFID microchips installed in gaming chips, plaques or jetons, and other value tokens provide a secure and reliable way to track and record the movement of the value token throughout a casino, for example. Because each value token has a unique RFID tag that is encoded with the value token's monetary value, it can be instantly identified and validated when it is placed in the detection range of an RFID reader. Thus, value tokens having integrated RFID tags provide an ideal way to improve the accuracy of counting and cage inventory procedures for value tokens in casinos while also providing a level of currency security that is very difficult to breach. By using an RFID chip tray or float reader, a casino also may automate and perfect its counting procedures, enabling the casino staff and pit supervisors to focus on other tasks.

RFID chip trays have been used to store such RFID-enabled gaming chips. For example, U.S. patent application Ser. No. 13/282,715, the contents of which are incorporated herein by reference, discloses an RFID chip tray for storing casino gaming chips. The disclosed RFID chip tray includes RFID antennas positioned within the housing to read and communicate with the RFID-enabled gaming chips. Such RFID chip trays are built to provide secure gaming chip storage for the bank of a casino table, to transport the RFID gaming chips throughout the gaming environment, as well as to provide authentication of RFID gaming chips including ownership, value, and the like. Such RFID chip trays are configured to authenticate from one to several hundred gaming chips in a single tray or in dual trays. The associated RFID reader may operate at both low and high RFID detection frequencies. In exemplary embodiments, such RFID chip trays may be used on the gaming table, on pit podiums, or in vault or reserves in the gaming table and facilitate storage and tracking of the RFID gaming chips stored in the RFID chip trays.

As shown in prior art FIG. 1, the RFID chip tray 10 is adapted to accept 39-45 mm diameter gaming chips in rack chip tubes in a single tray or in stacked trays. Typically, 10-15 such rack chip tubes are provided by denomination in one or more stacked trays. While such rack chip tubes may be configured to accommodate plaques, jetons, chips, and other various shaped gaming chips to measure inventory at the gaming table, it has been discovered in practice that it is difficult to read gaming chips and plaques or jetons in the same RFID chip tray with the gaming chips due to variations in size and spacing for the plaques or jetons as compared to the gaming chips. In particular, such RFID chip trays do not consistently read gaming chips or jetons with larger diameters (i.e. 48, 50, 60 mm) or gaming plaques that may be even bigger (e.g., 108 mm by 75 mm). The RFID antennas are incorporated into the RFID chip tray within a maximum distance to read the RFID tags of the conventional gaming chips; however, the rectangular, square, or other irregular shapes of the plaques and jetons pose difficulties for such readers as they lead to greater distances between the RFID antenna in the chip tray (e.g., 38 mm for a large jeton versus 20 mm for a conventional gaming chip, not including the width of the chip tray itself) and the center of the RFID tag in the plaque or jeton, leading to less reliable readings. With very large plaques, the RFID tags may even be out of range of the RFID antenna. Use of one RFID reading device for reading gaming chips as well as plaques or jetons has proven elusive.

Thus, it is desirable to provide a counterpart to the RFID chip tray for accommodating plaques and jetons of all shapes and sizes. Such devices will preferably include different RFID antenna designs to accommodate the larger sized plaques or jetons. The RFID plaque box of the invention has been designed to address these and other needs apparent from the following detailed description of the invention.

### SUMMARY

An RFID plaque box addresses the above-mentioned and other unspecified needs in the art by providing secure storage and protection of value tokens (e.g., gaming plaques and jetons) of all sizes and shapes (e.g., rectangular, square, oval or round) and delivering real-time counting and movement details like the afore-mentioned RFID chip trays in both high and low frequency RF environments. The RFID plaque box allows plaques or jetons to be accounted for as part of the table's inventory along with the RFID chip tray's inventory (when installed).

The RFID plaque box of the invention is adapted to sit on a gaming table, on a counter, or in a vault or reserve in the gaming table to store the value tokens. The RFID reader reads the stored RFID value tokens to provide real-time inventory. In a first embodiment, the RFID plaque box of the invention is provided as a fixed storage area that is situated below the plan of the gaming table alongside the RFID chip tray (when provided) with a lid very similar to that of the RFID chip tray. On the other hand, in a second embodiment, the RFID plaque box of the invention is provided with a pop-up mechanism whereby the RFID plaque box is integrated into a table or a counter such that when the top surface of the RFID plaque box is pushed, the RFID plaque box will pop-up to lift the stacks of plaques or jetons for access to all the stacks at the same time or to individual stacks depending on the pop-up mechanism. In either embodiment, the RFID antennas may be incorporated into the RFID plaque box; however, the RFID antennas also may be incorporated into a portion of the gaming table immediately adjacent the RFID plaque box, such as the portion of the device that is not lifted when the storage device “pops” up. In this latter embodiment, the reading of the RFID value tokens in the RFID plaque box may be performed only when the mechanism is closed. In this embodiment, to close, the user simply pushes the lift down to lock and secure it. Those skilled in the art will appreciate that such a locking mechanism is very important as plaques and jetons are very often used for high denominations. Those skilled in the art also will appreciate that the lift mechanism of the pop-up device may be motorized.

In exemplary embodiments, the plaque box for storing value tokens in accordance with the invention includes a housing having a plurality of compartments adapted to accept value tokens that do not have the size and dimensions of standard gaming chips and at least one RFID antenna positioned in or proximate to walls of the housing to communicate with RFID-enabled value tokens placed in one or more of the compartments of the housing. In a first embodiment, the plaque box is adapted for incorporation into a gaming table and preferably to interlock with an RFID chip tray. A lid is provided to prevent access to the housing when the lid is locked. In a second embodiment, a lift assembly is provided to lift the plaque box from a closed position beneath the gaming table into an opened position for access to the value tokens. The lift assembly is activated when a top surface of the RFID plaque box is pushed down to release the plaque box for lifting by the lift assembly. The lift assembly may comprise a spring that uncoils from a coiled position when the RFID plaque box is in the closed position to an uncoiled position when the RFID plaque box is in the opened position or a motor and a piston that lifts the RFID plaque box from the closed position to the opened position when the motor is activated. The at least one RFID antenna may be incorporated into a fixed wall beneath the gaming table immediately adjacent to the RFID plaque box so as to communicate with the RFID-enabled value tokens when the plaque box is in the closed position beneath the gaming table.

### BRIEF DESCRIPTION OF THE DRAWINGS

Embodiments of the invention can be better understood with reference to the following drawings.

FIG. 1 illustrates an RFID chip tray of the type disclosed in U.S. patent application Ser. No. 13/282,715.

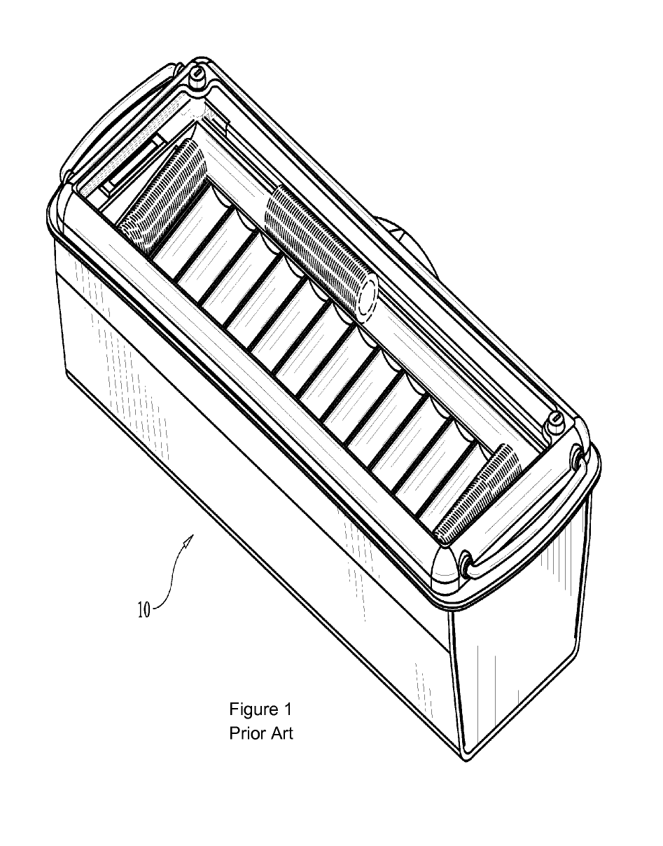

FIG. 2 illustrates a left-hand side view of a first embodiment of an RFID plaque box.

FIG. 3 illustrates a right-hand side view of the RFID plaque box in accordance with the first embodiment.

FIG. 4 illustrates the first embodiment of an RFID plaque box with its molded top attached.

FIG. 5 illustrates the first embodiment of an RFID plaque box used in conjunction with an RFID chip tray of the type described in U.S. patent application Ser. No. 13/282,715 to form an assembly for incorporation into a gaming table.

FIG. 6 illustrates the first embodiment of an RFID plaque box of FIG. 5 with the molded tops attached.

FIG. 7 illustrates a bottom view of the RFID plaque box and RFID chip tray assembly of FIG. 5.

FIG. 8 illustrates a cut-away side view of a second embodiment of an RFID plaque box including a pop-up assembly.

FIG. 9 illustrates a side view of the second embodiment of the RFID plaque box where the pop-up assembly is in a closed position.

FIG. 10 illustrates a side view of the second embodiment of the RFID plaque box where the pop-up assembly is in an opened position to permit access to the stored value tokens.

FIG. 11 illustrates an end view of the second embodiment of the RFID plaque box where the pop-up assembly is in an opened position to permit access to the stored value tokens.

FIG. 12 illustrates a top perspective view of the second embodiment of the RFID plaque box where the pop-up assembly is in the closed position with a removable cover attached.

FIG. 13 illustrates a top perspective view of the second embodiment of the RFID plaque box where the pop-up assembly is in the closed position with the removable cover removed and the RFID plaque box depressed and ready to raise up into the opened position.

FIG. 14 illustrates a top perspective view of the second embodiment of the RFID plaque box where the pop-up assembly is in the opened position to permit access to the stored value tokens.

### DETAILED DESCRIPTION OF ILLUSTRATIVE EMBODIMENTS

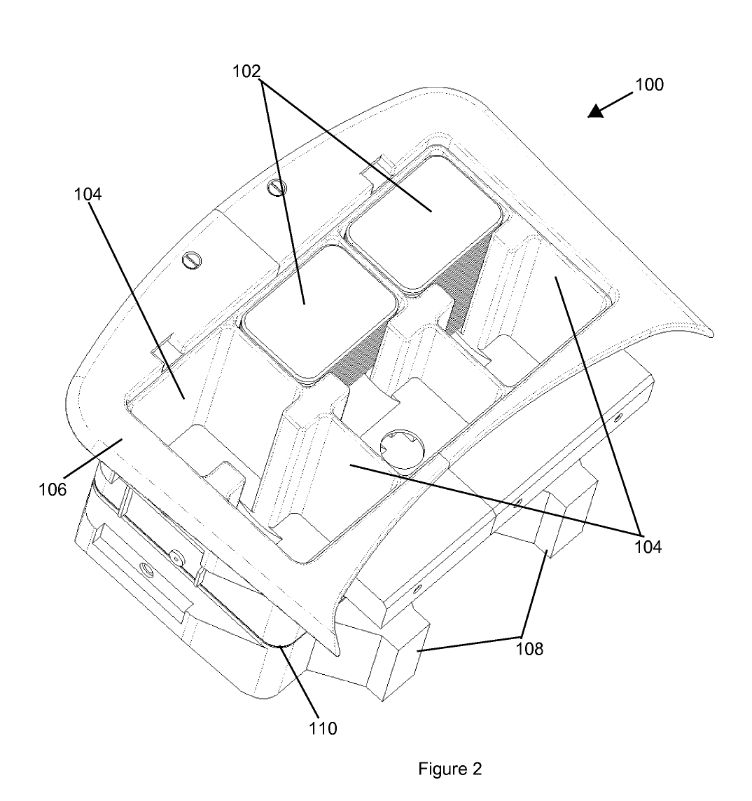

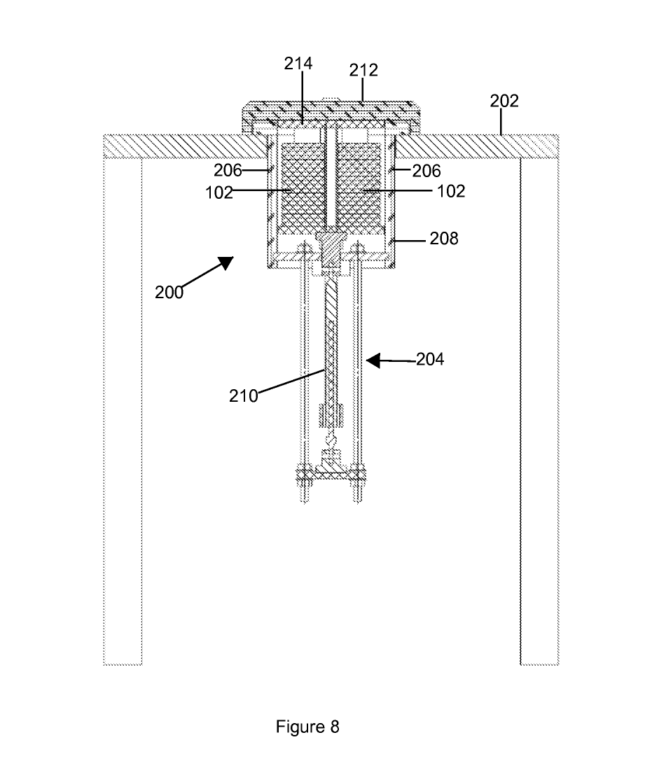

The invention will be described in detail below with reference to FIGS. 2-14. Those skilled in the art will appreciate that the description given herein with respect to those figures is for exemplary purposes only and is not intended in any way to limit the scope of the invention. All questions regarding the scope of the invention may be resolved by referring to the appended claims.

As noted above, a “value token” is a general term for physical objects that represent cash or other value and, in casino gaming embodiments, may be in the form of gaming chips, plaques, or jetons. For ease of description, the term “value token” is used interchangeably with “gaming chip,” “plaques,” or “jetons” herein, although it should be understood that, in each case of such use, a gaming chip, plaque, jeton, or other physical object such as a coin is contemplated as well.

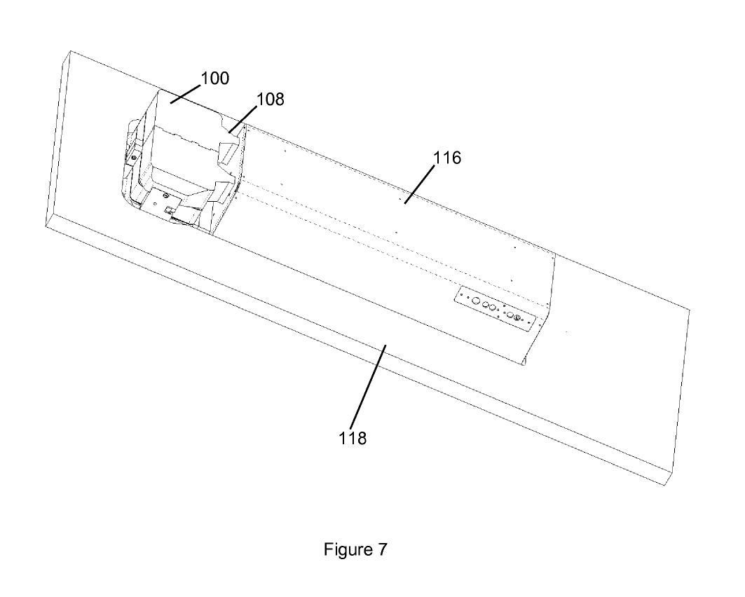

In a first embodiment of the RFID plaque box, the RFID plaque box is adapted for use with the RFID chip tray of the type described in U.S. patent application Ser. No. 13/282,715 to form an assembly for incorporation into a gaming table. As shown in FIG. 2, the RFID plaque box 100 is adapted to store plaques or jetons 102 of various sizes, shapes, and denominations. In exemplary embodiments, the RFID plaque box 100 includes divided sections 104 that are preformed into the shapes and sizes of the plaques or jetons 102 to be stored in the respective sections. In alternate embodiments, the divided sections 104 may comprise movable dividers to accommodate plaques or jetons 102 of varied sizes and shapes or all of the divided sections 104 may be part of a single basket insert that is dropped down into the storage box 106 when different configurations of divided sections 104 are desired. Storage box 106 is preferably made of a nonmetallic material such as plastic to minimize interference with the RFID field. It will be appreciated that while the divided sections 104 are shown as rectangular in shape that the divided sections 104 may have any desired shape to accept comparably shaped plaques or jetons 102. As also illustrated, protrusions 108 are adapted to interlock the RFID plaque box 100 to a cooperating RFID chip tray 116 as best shown in FIG. 7.

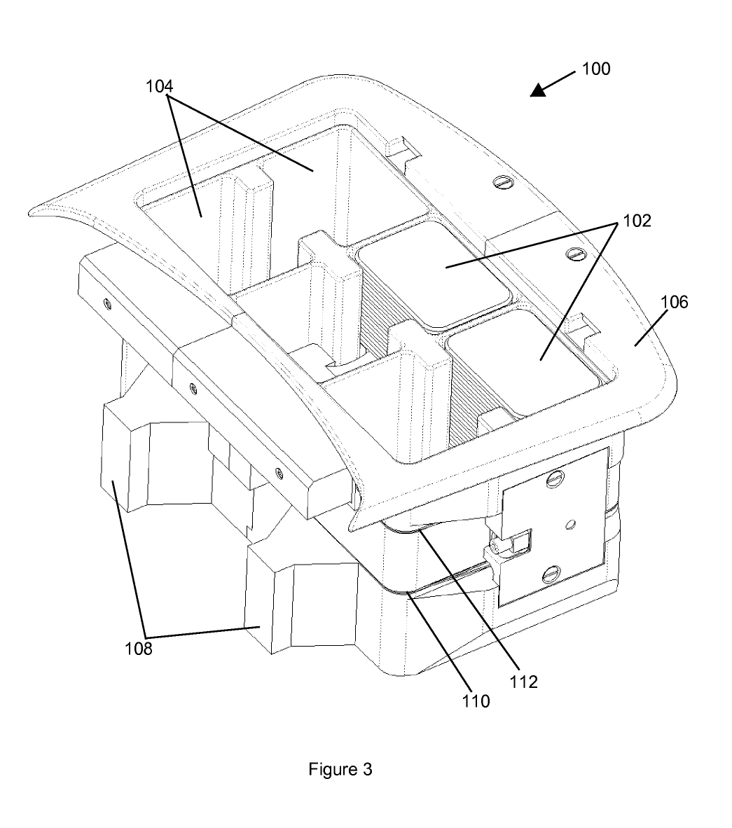

As better seen in FIG. 3, the RFID plaque box 100 includes an RFID antenna comprising at least two coils 110 and 112 that are wrapped around the walls of the storage box 106 to form two parallel RFID detection coils. Of course, it will be appreciated by those skilled in the art that only one coil needs to be used for smaller stacks. As shown in FIG. 3, the coils 110 and 112 wrap around the storage box 106, not under the storage box 106 and are thus sufficiently close to the plaques or jetons 102 stored in the divided sections 104. In exemplary embodiments, six stacks of 20 or more plaques or jetons 102 are provided in the storage box 106, although more or less divided sections 104 may be provided and more or less plaques or jetons 102 may be accommodated in each stack. Of course, for deeper stacks, more RFID detection coils would need to be provided to provide sufficient sensitivity. Also, detection sensitivity may be further increased by providing the RFID detection coils 110, 112, etc. in the walls of the divided sections 104. In any case, the RFID detection coils are preferably configured so as to not be capable of reading gaming chips from an associated RFID chip tray (if any) to minimize interference.

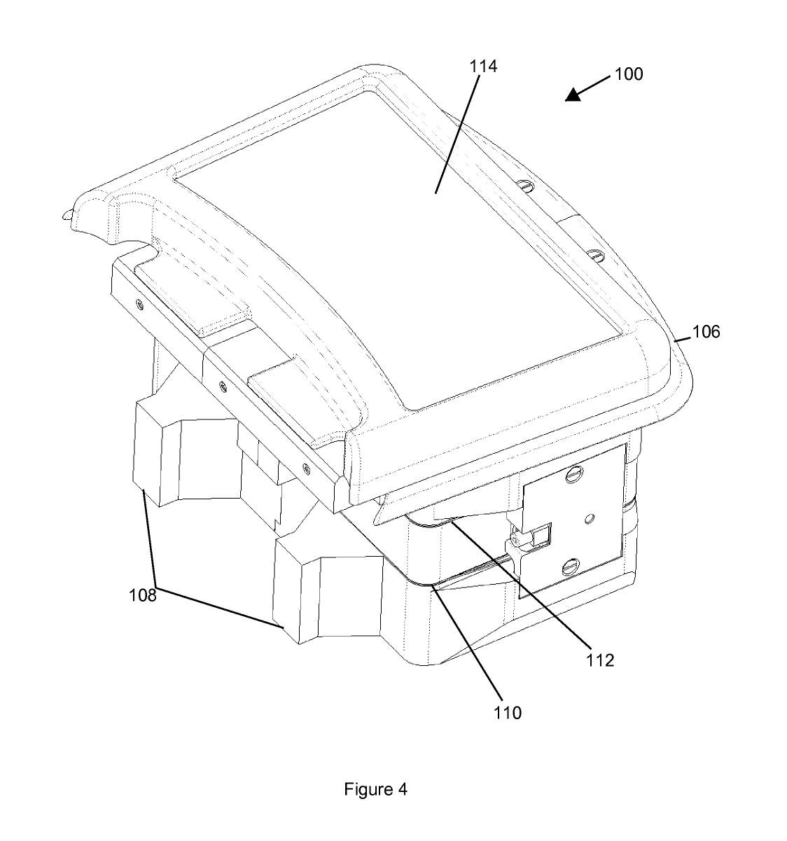

As illustrated in FIG. 4, the RFID plaque box 100 is preferably adapted to include a molded cover 114 that securely protects the contents of the RFID plaque box 100 until it is to be put into service. The molded cover 114 of the RFID plaque box 100 may be adapted to slide underneath a lid handle of a cooperating RFID chip tray 116 to hook with the lid handle to make it part of the lid of the RFID chip tray 116 when locked. Preferably, the molded cover 114 of the RFID plaque box 100 is locked in place by a lock or other known security device.

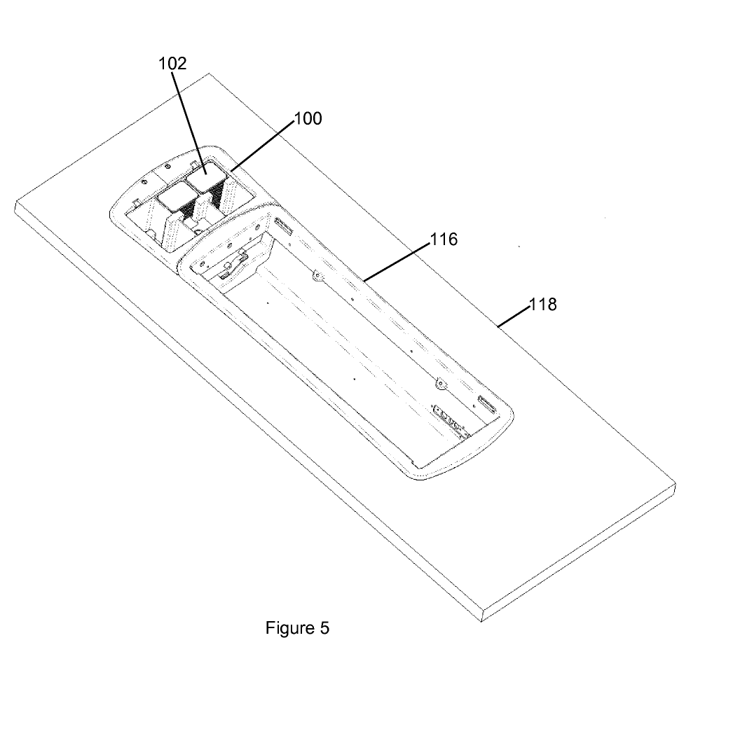

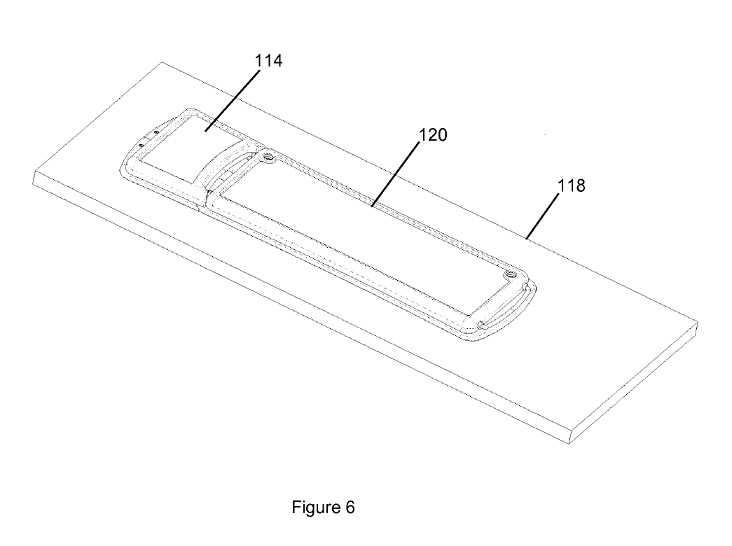

FIG. 5 illustrates the first embodiment of an RFID plaque box 100 used in conjunction with an RFID chip tray 116 of the type described in U.S. patent application Ser. No. 13/282,715 to form an assembly for incorporation into a gaming table 118. FIG. 6 illustrates the assembly of FIG. 5 with the molded tops 114 and 120 attached to the RFID plaque box 100 and RFID chip tray 116, respectively, so as to look like a one-piece unit. FIG. 7 illustrates a bottom view of the assembly including RFID plaque box 100 and RFID chip tray 116 of FIG. 5 incorporated into gaming table 118.

In a second embodiment of the RFID plaque box, the RFID plaque box 200 is adapted for incorporation into a gaming table 202 whereby the RFID plaque box 200 is securely stored under the gaming table 202 until needed. The RFID plaque box 200 is adapted into a manual or motorized lift mechanism 204 to rise up from under the gaming table 202 when access to the stored plaques or jetons 102 is desired. Since plaques or jetons 102 may weigh 30 grams or more each and upwards of 120 plaques or jetons 102 may be stored in the RFID plaque box 200, a motorized lift mechanism 204 is typically desired due to the weight (3-4+kilograms) to be lifted.

In the second embodiment, the RFID plaque box 200 is similar to RFID plaque box 100 except that RFID plaque box 200 is adapted to be lifted above the table 202 by lift mechanism 204 and in that the RFID detection coils 206 are preferably included in walls 208 of a portion of the gaming table 202 immediately adjacent the RFID plaque box 200. In this configuration, the plaques or jetons 102 in the RFID plaque box 200 are only read by the RFID detection coils 206 when the RFID plaque box 200 is in the closed and locked position beneath the gaming table 202. Of course, the RFID detection coils 206 may also remain in the walls of the RFID plaque box 200 as in the first embodiment so that the RFID detection may occur even when the RFID plaque box 200 is in the opened position for access to the plaques or jetons 102.

The lift mechanism 204 may include a mechanical spring 210 that pushes upward on the RFID plaque box 200 when cover 212 is removed and the top 214 of the RFID plaque box 200 is pushed down to release catches (not shown). The uncoiling of the spring 210 causes the RFID plaque box 200 to be pushed upward. Damping of the spring 210 prevents the spring 210 from uncoiling too quickly. Conversely, the spring 210 may be replaced by a motor assembly that pushes a piston (not shown) upward to raise the RFID plaque box 200 upward to the opened position when the top 214 of the RFID plaque box 200 is pushed down to release catches (not shown).

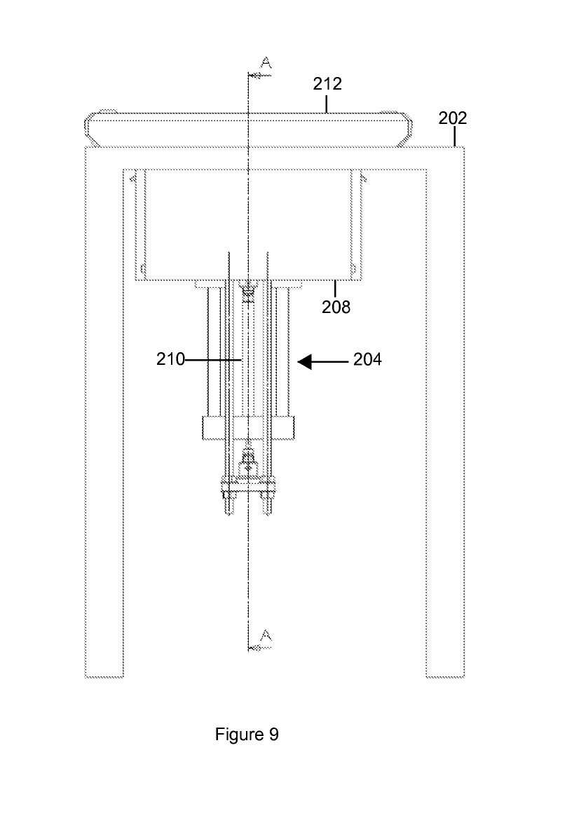

FIG. 9 illustrates a side view of the RFID plaque box 200 where the pop-up assembly is in a closed position. As noted above, the RFID detection coils 206 may be incorporated into fixed walls 208 so that the RFID devices of plaques or jetons 102 communicate with the RFID reader only when the RFID plaque box 200 is in the closed position.

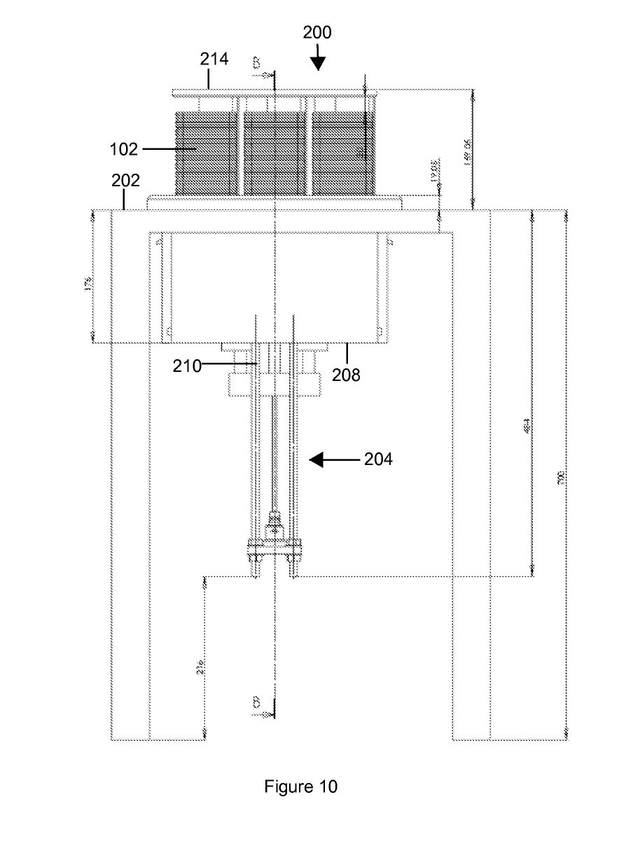

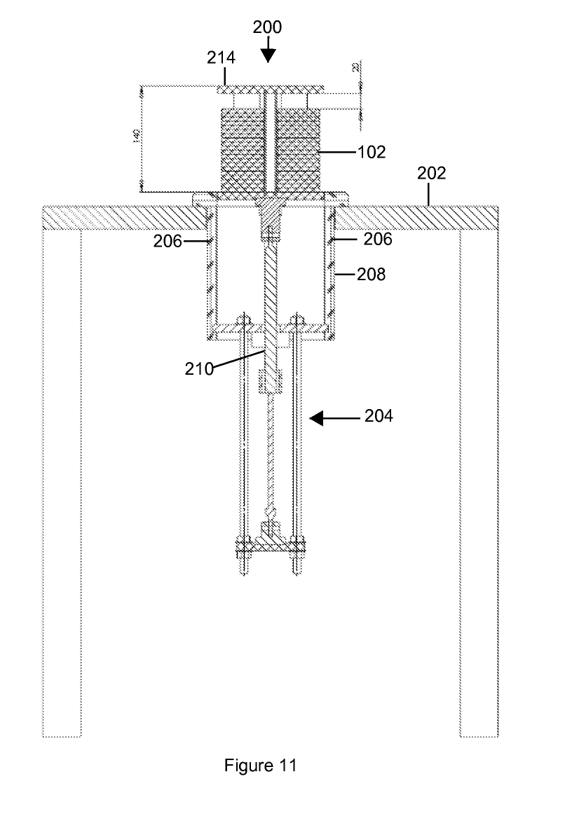

FIG. 10 illustrates a side view of the RFID plaque box 200 where the pop-up assembly is in an opened position to permit access to the stored plaques or jetons 102, while FIG. 11 illustrates a cutaway end view where the pop-up assembly is in an opened position to permit access to the stored plaques or jetons 102.

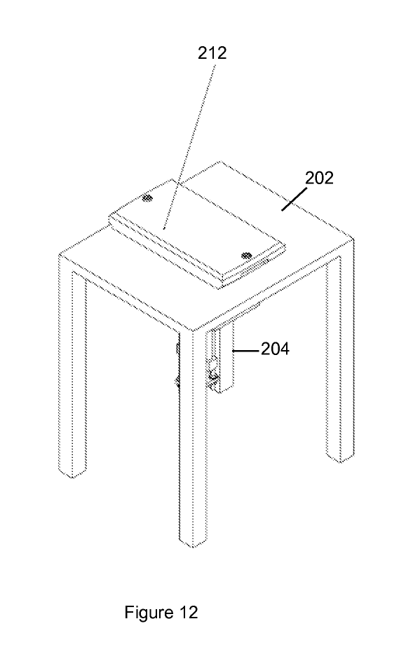

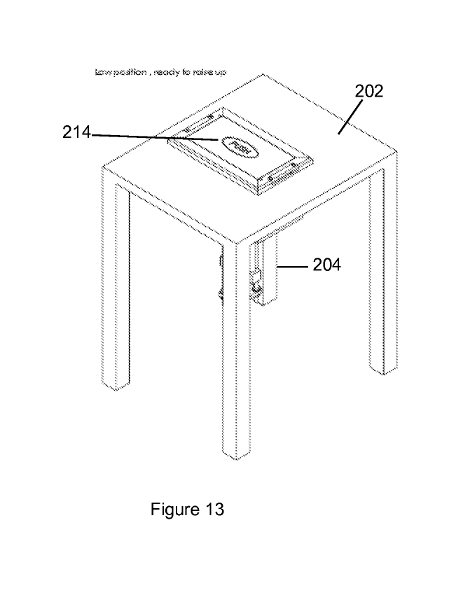

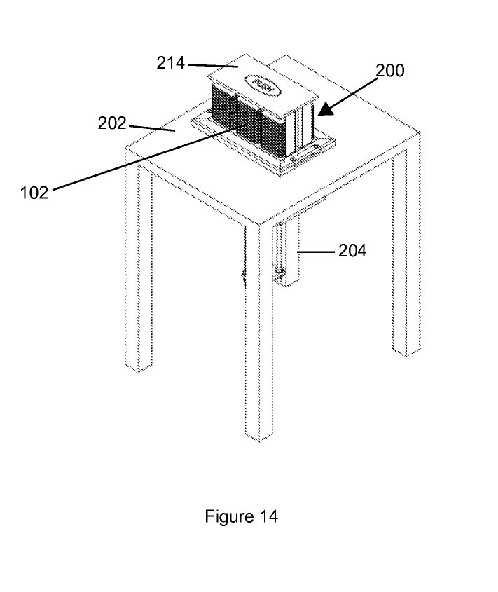

FIG. 12 illustrates a top perspective view of the second embodiment of the RFID plaque box where the pop-up assembly is in the closed position with a removable cover 212 attached. FIG. 13 illustrates a top perspective view of the RFID plaque box 200 where the pop-up assembly is in the closed position with the removable cover 212 removed and the top 214 (labeled “PUSH”) depressed so that the RFID plaque box 200 is ready to raise up into the opened position as shown in FIG. 14 to permit access to the stored plaques or jetons 102.

Those skilled in the art will appreciate that the embodiments described herein permit value tokens of all sizes and shapes to be read with a single RFID reader such as a Magellan Multiple Antenna Reader System (MARS-24) or other RFID reader available on the market for verifying, monitoring and controlling the movement of value tokens including RFID tags therein. The RFID plaque box described herein may be incorporated into a gaming table as described or may be used on top or beside the gaming table or on a separate cart or table. The RFID plaque box described herein also may be adapted to accommodate oversized or undersized gaming chips having RFID tags therein as well as value tokens that are square, rectangular, pentagonal, hexagonal, or any other shape. Such an RFID plaque box provides operators with instant and accurate information on the float balance and all movement of value tokens including plaques and jetons so that the operator has more understating of the usage of the value tokens and game delays may be reduced since manual counts will not be necessary.

Those skilled in the art will appreciate that the invention may be applied to other applications and may be modified without departing from the scope of the invention. Accordingly, the scope of the invention is not intended to be limited to the exemplary embodiments described above, but only by the appended claims.

What is claimed:

1. A plaque box for storing value tokens, comprising:
a housing having a plurality of compartments adapted to accept value tokens that do not have the size and dimensions of standard gaming chips; and
at least one RFID antenna positioned in or proximate to walls of said housing to communicate with RFID-enabled value tokens placed in one or more of said compartments of said housing.

2. A plaque box as in claim 1, wherein the plaque box is adapted for incorporation into a gaming table.

3. A plaque box as in claim 2, wherein the plaque box is adapted to interlock with an RFID chip tray.

4. A plaque box as in claim 1, further comprising a lid adapted to lock to prevent access to the housing when the lid is locked.

5. A plaque box as in claim 2, further comprising a lift assembly adapted to lift the plaque box from a closed position beneath the gaming table into an opened position for access to the value tokens.

6. A plaque box as in claim 5, wherein the lift assembly is activated when a top surface of the RFID plaque box is pushed down to release the plaque box for lifting by the lift assembly.

7. A plaque box as in claim 6, wherein the lift assembly comprises a spring that uncoils from a coiled position when the RFID plaque box is in the closed position to an uncoiled position when the RFID plaque box is in the opened position.

8. A plaque box as in claim 6, wherein the lift assembly comprises a motor and a piston that lifts the RFID plaque box from the closed position to the opened position when the motor is activated.

9. A plaque box as in claim 5, wherein the at least one RFID antenna is incorporated into a fixed wall beneath the gaming table immediately adjacent to the RFID plaque box so as to communicate with the RFID-enabled value tokens when the plaque box is in the closed position beneath the gaming table.
